(19) United States
(12) Patent Application Publication
(10) Pub. No.: US 2022/0240482 A1
(43) Pub. Date: Aug. 4, 2022

(54) PET CAGE

(71) Applicant: Weiping YANG, Shenzhen (CN)

(72) Inventor: Weiping YANG, Shenzhen (CN)

(21) Appl. No.: 17/220,416

(22) Filed: Apr. 1, 2021

(30) Foreign Application Priority Data
Feb. 3, 2021 (CN) 202120309014.7

(51) Int. Cl. A01K 1/02

(52) U.S. Cl. CPC A01K 1/0245

(57) ABSTRACT

Disclosed is a pet cage, including a cage body having a cage opening and a door body for covering the cage opening. The cage body is provided with a rotating shaft at one end of the cage opening and a hanging bar at the other end of the cage opening, the hanging bar and the rotating shaft are oppositely disposed. The door body is provided with a rotation portion on one side and a hook portion on the other side, the rotation portion includes a rotation groove, the hook portion includes a hook groove opposite to the rotation groove. The rotating shaft is configured to be sheathed inside the rotation groove so that the rotation portion is rotatably connected to the rotating shaft, and the hook portion is hooked to the hanging bar. The depth of the rotation groove is greater than the depth of the hook groove.

### CROSS-REFERENCE TO RELATED APPLICATIONS

This application is based on and claims the benefit of priority from Chinese Patent Application No. 202120309014.7, filed on 3 Feb. 2021, the entirety of which is incorporated by reference herein.

### TECHNICAL FIELD

The present disclosure relates to a pet appliance, in particular, a pet cage.

### BACKGROUND

People love to keep pets as living standards are improved. Pet cages are needed for keeping pets. Generally, a pet cage includes a cage body and a cage door mounted on the cage body. People usually need to lock the cage door to prevent pets from accidentally opening the cage door and consequently running outside or getting lost, and also to prevent some large pets from injuring their keepers or others. However, it is inconvenient to use a lockset to open and close the cage door. Therefore, there is a need for new pet cage design.

### SUMMARY

An objective of the present disclosure is to provide a pet cage to solve one or more technical problems in the existing technology, and provide at least one beneficial selection or creation condition.

Certain embodiments of the present disclosure solve the problem by designing a switch that can prevent pets from accidentally opening the cage door, without using a lockset.

Certain embodiments of the present disclosure provide a pet cage, including a cage body having a cage opening, and a door body configured to cover the cage opening. The cage body is provided with a rotating shaft at one end of the cage opening and a hanging bar at the other end of the cage opening, and the hanging bar and the rotating shaft are oppositely disposed. The door body is provided with a rotation portion on one side and a hook portion on the other side, the rotation portion includes a rotation groove, the hook portion includes a hook groove, and the rotation groove and the hook groove are oppositely disposed. The rotating shaft is configured to be sheathed inside the rotation groove so that the rotation portion is rotatably connected to the rotating shaft, and the hook portion is configured to be hooked to the hanging bar. The rotation groove has a depth greater than a depth of the hook groove.

In the present disclosure, the door body is provided with the rotation portion including the rotation groove and the hook portion including the hook groove, and the door body is opened and locked by using the rotation groove and the hook groove. The structure is simple, and the operations are simple, thereby improving usage convenience of the pet cage.

In some embodiments, the door body includes a door sheet, one end of the rotation portion is configured to connect to the door sheet, and the other end of the rotation portion is provided with a fold-over edge.

In some embodiments, the fold-over edge is disposed at one end of the rotation portion, so that the door body can be mounted more easily, and the strength of the rotation portion can be improved.

In some embodiments, the rotation portion is in a U shape, and a bottom of the rotation portion is in an arc shape. The bottom of the rotation portion is arranged in the arc shape, so that the door body can be rotated more smoothly.

In some embodiments, the rotation portion is disposed on a bottom edge of the door sheet, and the bottom edge of the door sheet is further provided with a support boss. The support boss enables the door body to be better fastened when the door body is closed.

In some embodiments, an abutting portion is provided on a top edge of the door sheet, and the abutting portion is configured to abut against the cage body. With the abutting portion, accidental opening of the door body can be avoided.

In some embodiments, the door sheet is provided with a handle. The handle facilitates the operations on the door body.

In some embodiments, the door sheet is provided with a reinforcing rib. The reinforcing rib can improve the strength of the door body.

### BRIEF DESCRIPTION OF DRAWINGS

To describe the technical solutions in the embodiments of the present disclosure more clearly, the following briefly describes the accompanying drawings required for describing the embodiments. Apparently, the accompanying drawings in the following description show merely some rather than all embodiments of the present disclosure, and a person skilled in the art may derive other design solutions and drawings from these accompanying drawings without creative efforts.

FIG. 1 is a schematic structural diagram according to the present disclosure;

FIG. 2 is another schematic structural diagram according to the present disclosure; and

FIG. 3 is a schematic diagram of a usage state according to the present disclosure.

### DETAILED DESCRIPTION

The following clearly and thoroughly describes the concepts, specific structures, and generated technical effects of the present disclosure with reference to the embodiments and accompanying drawings for comprehensive understanding of the purposes, features, and effects of the present disclosure. Apparently, the described embodiments are merely some rather than all of the embodiments of the present disclosure. Other embodiments obtained by a person skilled in the art based on the embodiments of the present disclosure without creative efforts shall fall within the protection scope of the present disclosure. Certain embodiments of the present disclosure are illustrated in the accompanying drawings. The accompanying drawings are intended to supplement the text descriptions of the specification with graphics, so that each technical feature and an overall technical solution of the present disclosure can be intuitively and visually understood, but cannot be construed as a limitation on the protection scope of the present disclosure.

In the descriptions of the present disclosure, it should be understood that directions or position relationships indicated by direction-related descriptions “up”, “down”, “front”, “rear”, “left”, “right”, and the like are based on the directions or position relationships shown by the accompanying drawings, which are used only for describing the present disclosure and for brevity of description, but do not indicate or imply that an indicated apparatus or element must have a specific direction or must be constructed and operated in a specific direction. Therefore, this cannot be understood as a limitation on the present disclosure.

In the descriptions of the present disclosure, “several” means one or more; “a plurality of means two or more; “greater than”, “less than”, “more than”, and the like are understood as excluding the current number; and “above”, “below”, “within”, and the like are understood as including the current number. The terms “first” and “second” (if any) in the descriptions are merely intended to distinguish between technical features, and shall not be understood as an indication or implication of relative importance or an implicit indication of the number of indicated technical features or an implicit indication of the sequence of indicated technical features.

In the descriptions of the present disclosure, unless otherwise specifically limited, terms such as “dispose”, “mount”, and “connect” should be understood in a broad sense. A person skilled in the art can properly determine specific meanings of the foregoing terms in the present disclosure with reference to specific content of the technical solutions. In addition, the technical features in the present invention may be interactively combined, provided that there is no conflict.

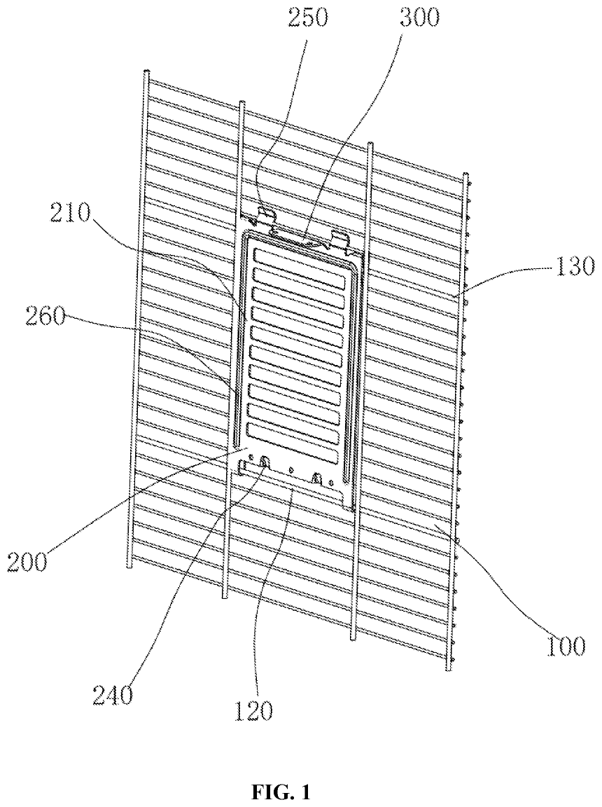

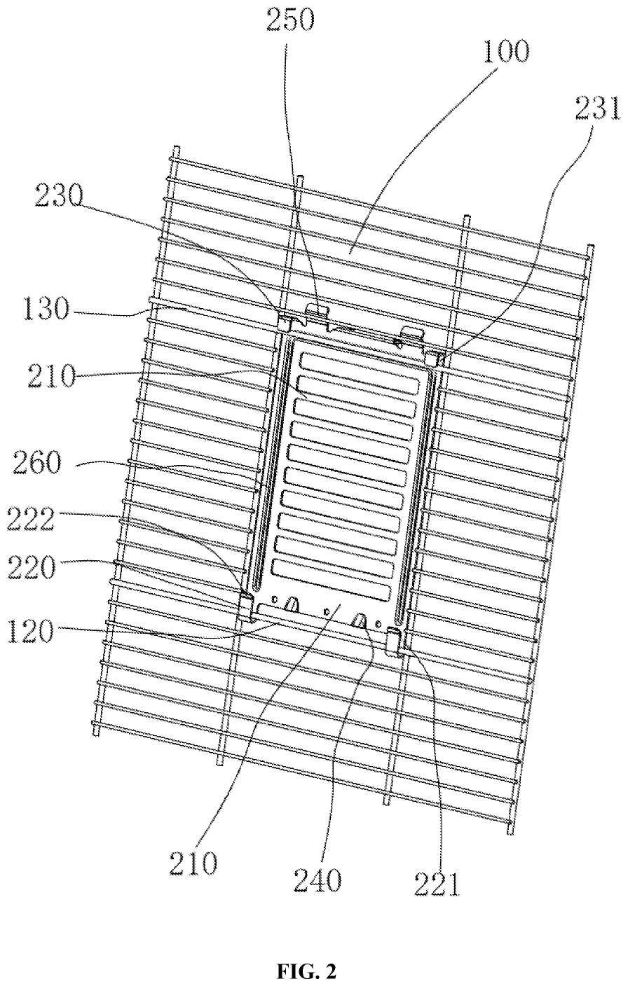

Referring to FIG. 1 to FIG. 3, a pet cage includes a cage body 100 comprising a cage opening 110, and a door body 200 configured to cover the cage opening 110. The cage body 100 is provided with (or comprises) a rotating shaft 120 at one end of the cage opening 110 and a hanging bar 130 at the other end of the cage opening 110, and the hanging bar 130 and the rotating shaft 120 are oppositely disposed. The door body 200 includes a door sheet 210, and a rotation portion 220 is disposed on the lower side of the door sheet 210. One end of the rotation portion 220 connects to the door sheet 210, and the other end of the rotation portion 220 is provided with a fold-over edge 222. A hook portion 230 is disposed on the upper side of the door sheet 210. The rotation portion 220 includes a rotation groove 221, the hook portion 230 includes a hook groove 231, and the rotation groove 221 and the hook groove 231 are oppositely disposed. When the door sheet 210 covers the cage opening 110, as shown in FIG. 2, an opening of the rotation groove 221 faces upward, and an opening of the hook groove faces downward. The rotating shaft 120 is sheathed inside the rotation groove 221 so that the rotation portion 220 is rotatably connected to the rotating shaft 120, and the hook portion 230 is configured to be hooked to the hanging bar 130. The depth of the rotation groove 221 is greater than the depth of the hook groove 231. The door sheet 210 is provided with a handle 300.

Referring to FIG. 1 and FIG. 2, when the pet cage of the present disclosure is assembled, only the rotation portion 220 of the door body 200 needs to be buckled to the rotating shaft 120, and then the door body 200 is rotated, so that the hook portion 230 is buckled to the hanging bar 130 and the door body 200 blocks the cage opening.

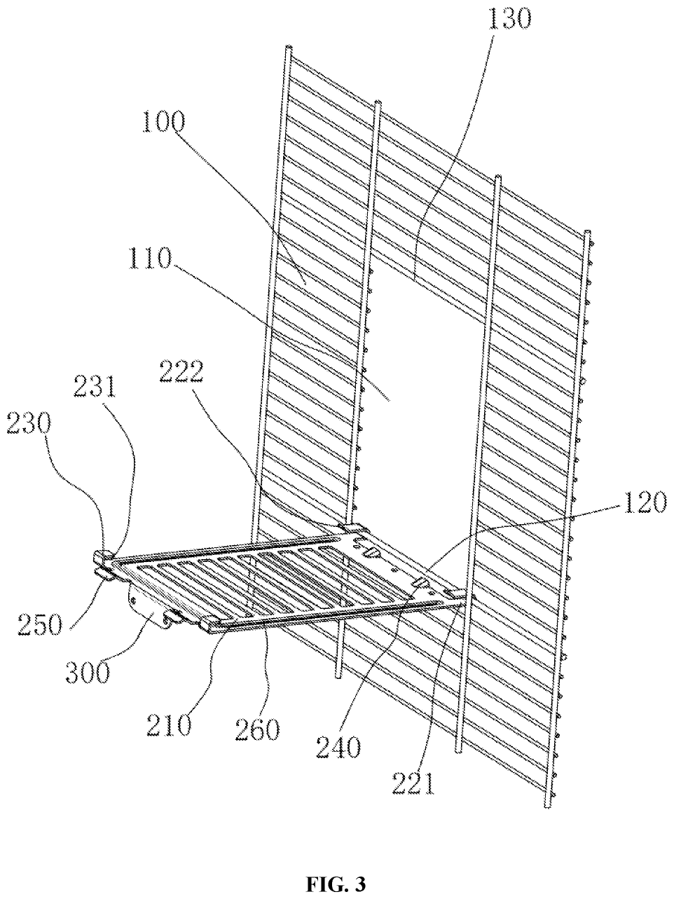

When the door body 200 needs to be opened, the handle 300 is held by a hand to lift the door body 200, so that the hook portion 230 is separated from the hanging bar 130. After the separation, because the rotating shaft 120 is still sheathed inside the rotation portion 220, the door body 200 can be flipped outward, so that the door body 200 is flipped downward and opened. FIG. 3 shows a case that the door body 200 is opened.

When the door body 200 needs to be closed, the handle 300 is held by a hand to flip the door body 200 upward, so that the hook portion 230 is located directly above the hanging bar 130, and the hook groove 231 faces the hanging bar 130. Then, the door body 200 is released, which drops under the effect of gravity, so that the hook portion 230 is hooked to the hanging bar 130. The rotating shaft 120 is always sheathed inside the rotation portion 220. With the coordination of the hook portion 230 and the rotation portion 220, the door body 200 tightly blocks the cage opening 110, thereby effectively preventing pets from escaping. In addition, self-locking is implemented through self-gravity of the door body 200 without the need for a conventional cage lock structure. The structure is simpler and is easier to use.

In some embodiments, the rotation portion 220 is in a U shape, and the bottom of the rotation portion 220 is in an arc shape. There are two rotation portions 220, and the two rotation portions 220 are respectively located on the left and right sides at the bottom end of the door sheet 210. Similarly, there are also two hook portions 230, and the two hook portions 230 are respectively located on the left and right sides at the top end of the door sheet 210.

In some embodiments, the bottom edge of the door sheet 210 is further provided with a support boss 240. When the door sheet 210 is closed, the bottom of the door sheet 210 abuts against the rotating shaft 120 with the support boss 240, the bottom surface of the hook groove 231 abuts against the top surface of the hanging bar 130, so that the force acting on the hanging bar 130 is shared by the rotating shaft 120.

In some embodiments, an abutting portion 250 is provided on a top edge of the door sheet 210, and the abutting portion 250 is configured to abut against the cage body 100. The cross-section of the abutting portion 250 may be in a V shape. Generally, the cage body 100 includes a plurality of cross arms, and a gap is reserved between the cross arms. When the door body 200 is closed, a tip of the abutting portion 250 is stuck between the cross arms. The abutting portion 250 plays a blocking function to some extent, thereby effectively reducing the risk of accidentally opening the door body 210. When the door needs to be opened, the door sheet 210 is vigorously lifted. In the process of lifting the door sheet 210, because the abutting portion 250 is elastic to some extent, the abutting portion 250 is separated from the cage body 110.

In addition, because there is a gap between the door sheet 210 and the cage body 100 in the forward-and-backward direction, the door sheet 210 may be slightly pulled out, so that the abutting portion 250 is separated from the cage body 100 for more convenient opening.

In some embodiments, the door sheet 210 is provided with a reinforcing rib 260. The reinforcing rib 260 is annular and surrounds the outline of the door sheet 210.

In some embodiments, the door sheet 210, the rotation portion 220, the hook portion 230, the support boss 240, the abutting portion 250, and the reinforcing rib 260 are integrally formed. Processing and forming the door body 200 by using one steel plate can improve the processing efficiency of the door body 200 and enhance the overall strength of the door body 200.

In some embodiments, the handle 300 is also integrally formed with the door body 200.

Implementations of the present disclosure are described in detail above. However, the present invention is not limited to the embodiments. A person skilled in the art may further make various equivalent variations or replacements without departing from the principles of the present disclosure. These equivalent variations or replacements all fall within the scope of the claims of the present application.

What is claimed is:

1. A pet cage, comprising a cage body that comprises a cage opening, and a door body configured to cover the cage opening, wherein
the cage body is provided with a rotating shaft at one end of the cage opening and a hanging bar at the other end of the cage opening, and the hanging bar and the rotating shaft are oppositely disposed;
the door body is provided with a rotation portion on one side and a hook portion on the other side, the rotation portion comprises a rotation groove, the hook portion comprises a hook groove, the rotation groove and the hook groove are oppositely disposed;
the rotating shaft is configured to be sheathed inside the rotation groove so that the rotation portion is rotatably connected to the rotating shaft, and the hook portion is configured to be hooked to the hanging bar; and
the rotation groove has a depth greater than a depth of the hook groove.

2. The pet cage of claim 1, wherein the door body comprises a door sheet, one end of the rotation portion is configured to connect to the door sheet, and the other end of the rotation portion is provided with a fold-over edge.

3. The pet cage of claim 2, wherein the rotation portion is in a U shape, and a bottom of the rotation portion is in an arc shape.

4. The pet cage of claim 2, wherein the rotation portion is disposed on a bottom edge of the door sheet, and the bottom edge of the door sheet is further provided with a support boss.

5. The pet cage of claim 4, wherein an abutting portion is provided on a top edge of the door sheet, and the abutting portion is configured to abut against the cage body.

6. The pet cage of claim 2, wherein the door sheet is provided with a handle for a user to open or close the door sheet.

7. The pet cage of claim 2, wherein the door sheet is provided with a reinforcing rib.
